(19) United States
(12) Patent Application Publication
(10) Pub. No.: US 2021/0256710 A1
(43) Pub. Date: Aug. 19, 2021

(54) PROCESSING APPARATUS, PROCESSING METHOD, AND NON-TRANSITORY STORAGE MEDIUM

(71) Applicant: NEC CORPORATION, Tokyo (JP)

(72) Inventors: Jianquan LIU, Tokyo (JP); Maguell Luka Timir Lano SANDIFORT, Tokyo (JP)

(73) Assignee: NEC CORPORATION, Tokyo (JP)

(21) Appl. No.: 17/253,376

(22) PCT Filed: Jun. 22, 2018
(86) PCT No.: PCT/JP2018/023812

§ 371 Date: Dec. 17, 2020

(51) Int. Cl. G06T 7/20; G08B 13/196; G06T 7/11

(52) U.S. Cl. CPC G06T 7/20; G08B 13/19602; G06T 2207/30196; G06T 2207/20021; G06T 2207/30232; G06T 7/11

(57) ABSTRACT

Provided is a processing apparatus (10) including: a moving body detection unit (11) that detects a moving body from an image generated by a camera, a computation unit (12) that computes a movement parameter value which indicates a characteristic of a movement of each moving body for each moving body, and computes an index which indicates variation in the movement parameter value for each moving body, and a target extraction unit (13) that extracts the moving body which satisfies a predetermined condition, based on the index.

### TECHNICAL FIELD

The present invention relates to a processing apparatus, a processing method, and a program.

### BACKGROUND ART

Patent Document 1 discloses a technique for detecting a person from an image and extracting a person for which an appearance frequency to an image is higher than a predetermined level from the detected persons.

Non-Patent Documents 1 to 5 disclose techniques for analyzing images and extracting a person who exhibits a predetermined behavior.

Patent Documents 2 and 3 disclose a technique of indexing persons detected from an image and using the index to group persons who are similar in appearance by a predetermined level or more.

### RELATED DOCUMENT

### Patent Document

[Patent Document 1] International Publication No. WO2017/077902
[Patent Document 2] International Publication No. WO2014/109127
[Patent Document 3] Japanese Patent Application Publication No. 2015-49574

### Non-Patent Document

[Non-Patent Document 1] Ke, S. R., Thuc, H. L. U., Lee, Y. J., Hwang, J. N., Yoo, J. H., & Choi, K. H. (2013). A review on video-based human activity recognition. Computers, 2(2), 88-131.
[Non-Patent Document 2] Tomas, R. M., Tapia, S. A., Caballero, A. F, Ratte, S., Eras, A. G., & Gonzalez, P. L. (2015, June). Identification of loitering human behaviour in video surveillance environments. In International Work-Conference on the Interplay Between Natural and Artificial Computation (pp. 516-525). Springer, Chain.
[Non-Patent Document 3] Bouma, H., Baan, J., Landsmeer, S., Kruszynski, C., van Antwerpen, G., & Dijk, J. (2013). Real-time tracking and fast retrieval of persons in multiple surveillance cameras of a shopping mall. Bellingham, Wash.: SPIE.
[Non-Patent Document 4] Nam, Y. (2015). Loitering detection using an associating pedestrian tracker in crowded scenes. Multimedia Tools and Applications, 74(9), 2939-2961.
[Non-Patent Document 5] Xiong, G., Wu, X., Chen, Y. L., & Ou, Y. (2011, June). Abnormal crowd behavior detection based on the energy model. In Information and Automation (ICIA), 2011 IEEE International Conference on (pp. 495-500). IEEE.

### SUMMARY OF THE INVENTION

### Technical Problem

In a case of a technique described in Patent Document 1 for extracting a person for which an appearance frequency to an image is higher than a predetermined level, not only a person who is prowling the place for a criminal inspection, but also a person who is staying at the place for a relatively long time simply for the purpose of meeting or the like is extracted. As described above, the technique described in Patent Document 1 does not have sufficient accuracy in extracting a suspicious person. Non-Patent Documents 1 to 5 and Patent Documents 2 and 3 do not present means for solving the problem.

An object of the present invention is to provide a technique for extracting a suspicious person included in an image with high accuracy.

### Solution to Problem

According to the present invention, there is provided a processing apparatus including:

a moving body detection unit that detects moving bodies from an image generated by a camera,

a computation unit that computes a movement parameter value which indicates a characteristic of a movement of each moving body for each of the moving bodies, and computes an index which indicates variation in the movement parameter value for each moving body, and

a target extraction unit that extracts the moving body which satisfies a predetermined condition, based on the index.

Further, according to the present invention, there is provided a processing method

executed by a computer, the method including

a moving body detection step of detecting a moving body from an image generated by a camera,

a computation step of computing a movement parameter value which indicates a characteristic of a movement of each of the moving bodies for each moving body, and computing an index which indicates variation in the movement parameter value for each moving body, and

a target extraction step of extracting the moving body which satisfies a predetermined condition, based on the index.

Further, according to the present invention, there is provided a program

causing a computer to function as:

a moving body detection unit that detects a moving body from an image generated by a camera,

a computation unit that computes a movement parameter value which indicates a characteristic of a movement of each of the moving bodies for each moving body, and computes an index which indicates variation in the movement parameter value for each moving body, and

a target extraction unit that extracts the moving body which satisfies a predetermined condition, based on the index.

### Advantageous Effects of Invention

According to the present invention, a technique for accurately extracting a suspicious person included in an image is realized.

### BRIEF DESCRIPTION OF THE DRAWINGS

The above and other objects, features and advantages will become more apparent from the preferred example embodiments described below and the accompanying drawings.

FIG. 1 is a diagram showing an example of a hardware configuration of a processing apparatus according to the present example embodiment.

FIG. 2 is a diagram showing an example of a functional block diagram of a processing apparatus according to the present example embodiment.

FIG. 3 is a diagram schematically showing an example of index information processed by a processing apparatus of the present example embodiment.

FIG. 4 is a flowchart showing an example of a processing flow of a processing apparatus of the present example embodiment.

FIG. 5 is a diagram for explaining processing of a computation unit of the present example embodiment.

FIG. 6 is a diagram for explaining an example of processing in which a computation unit of the present example embodiment computes a moving velocity.

FIG. 7 is a diagram showing a computation result (moving velocity) of a computation unit of the present example embodiment.

FIG. 8 is a diagram showing a computation result (moving velocity) of a computation unit of the present example embodiment.

FIG. 9 is a diagram for explaining an example of processing in which a computation unit of the present example embodiment computes a moving direction.

FIG. 10 is a diagram for explaining a specific example of processing in which a computation unit of the present example embodiment computes a moving direction.

FIG. 11 is a diagram for explaining a specific example of processing in which a computation unit of the present example embodiment computes a moving direction.

FIG. 12 is a diagram showing a computation result (moving direction) of a computation unit of the present example embodiment.

FIG. 13 is a diagram showing a computation result (moving direction) of a computation unit of the present example embodiment.

FIG. 14 is a diagram for explaining a modification example of processing in which a computation unit of the present example embodiment sets a small area in an image.

### DESCRIPTION OF EMBODIMENTS

### First Example Embodiment

First, an outline of the processing apparatus of the present example embodiment will be described. The processing apparatus detects a person from an image generated by a camera (for example, a surveillance camera), and then computes a movement parameter value (for example, moving velocity, moving direction, appearance position, and the like) which indicates a characteristic of a movement of each detected person, thereby extracting a suspicious person based on variation in the movement parameter value.

A person who is prowling for a criminal inspection or the like takes various actions such as searching for a target, tracking a target, and observing a target. The characteristic of such a person's movement is not constant and may vary. For example, the person may appear at different positions, move in different directions, or move at different velocities.

The processing apparatus of the present example embodiment that extracts a suspicious person based on variation in the movement parameter value indicating the characteristic of a movement allows the suspicious person to be extracted with high accuracy.

Hereinafter, the configuration of the processing apparatus will be described in detail. First, an example of a hardware configuration of the processing apparatus will be described. Each functional unit included in the processing apparatus is realized by any combination of hardware and software centering on a Central Processing Unit (CPU) of any computer, a memory, a program loaded into the memory, a storage unit (capable of storing, in addition to programs stored from the stage of shipment of the apparatus in advance, programs downloaded from storage media such as Compact Discs (CDs) and servers on the Internet.) such as a hard disk for storing the program and an interface for network connection. It will be understood by those skilled in the art that there are various modification examples in the method and apparatus for realizing the functional unit.

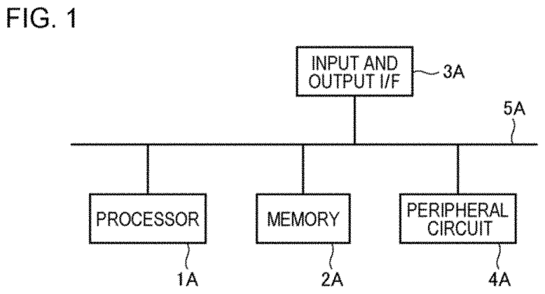

FIG. 1 is a block diagram illustrating a hardware configuration of a processing apparatus according to the present example embodiment. As shown in FIG. 1, the processing apparatus includes a processor 1A, a memory 2A, an input and output interface 3A, a peripheral circuit 4A, and a bus 5A. The peripheral circuit 4A includes various modules. Note that, the peripheral circuit 4A may not be provided.

The bus 5A is a data transmission path through which the processor 1A, the memory 2A, the peripheral circuit 4A, and the input and output interface 3A mutually transmit and receive data. The processor 1A is an arithmetic processing apparatus such as a Central Processing Unit (CPU) and a Graphics Processing Unit (GPU). The memory 2A is a memory such as a Random Access Memory (RAM) and a Read Only Memory (ROM). The input and output interface 3A includes interfaces for acquiring information from an input device (for example, a keyboard, a mouse, a microphone, and the like), an external apparatus, an external server, an external sensor, and the like, and interfaces for outputting information to an output device (for example, a display, a speaker, a printer, a mailer, and the like), an external apparatus, an external server, and the like. The processor 1A can issue a command to each module and perform a computation based on the computation results thereof.

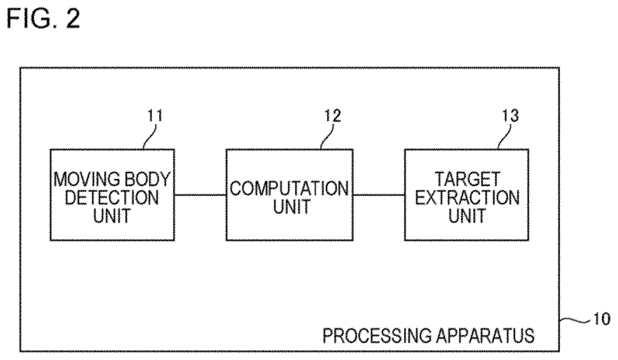

Next, the functional configuration of the processing apparatus will be described. As shown in the functional block diagram of FIG. 2, the processing apparatus 10 includes a moving body detection unit 11, a computation unit 12, and a target extraction unit 13. Hereinafter, each functional unit will be described in detail.

The moving body detection unit 11 detects a moving body from the image generated by the camera. The moving body is a person. The camera is, for example, a surveillance camera that photographs a moving image and continuously photographs a predetermined area.

The moving body detection unit 11 analyzes the image of each frame generated by the camera and detects persons from the image of each frame. The means that detects a person is not particularly limited, and any technique can be adopted.

Then, the moving body detection unit 11 groups the persons detected from the image of each frame by persons having the same or similar appearance (for example, face, clothes, and the like). Thereby, the same person existing over the images of a plurality of frames is put together.

The following can be considered as an example of the grouping processing. For example, the moving body detection unit 11 detects a person from each of the images of the plurality of frames. Then, the moving body detection unit 11 determines whether the appearance of the person detected from the image of a certain frame (frame being processed) and the appearance of the person detected from the image of the previous frame (processed frame) are similar to each other at a predetermined level or more, and groups persons having similarities at a predetermined level or more. The above determination may be performed by comparing all pairs of appearance features of each of all the persons detected from the image of the processed frame and appearance features of each of all the persons detected from the image of the frame being processed. However, in a case of such processing, as the accumulated data of the person increases, the number of pairs to be compared increases, and the processing load on the computer increases. Therefore, for example, the following method may be adopted.

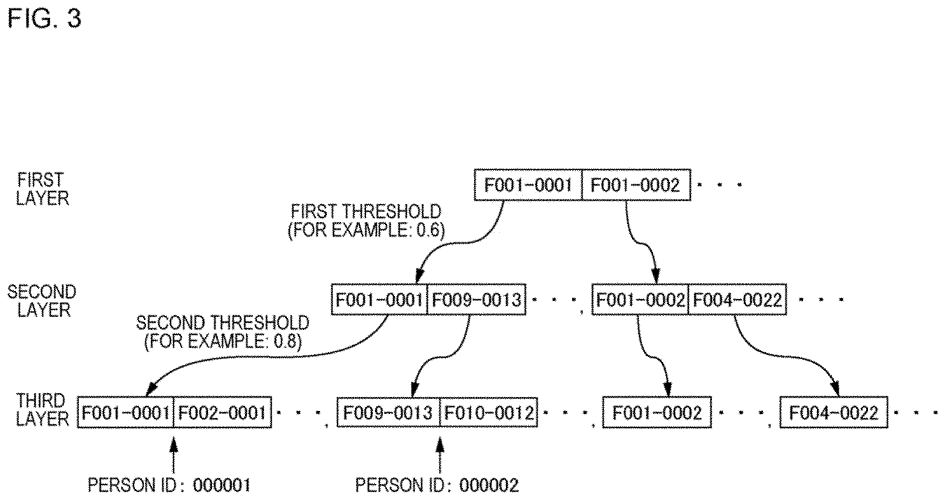

Specifically, the detected persons may be indexed as shown in FIG. 3, and the persons who are similar in appearance by a predetermined level or more may be grouped using the index. Details of the index and a method of generating the index are disclosed in Patent Documents 2 and 3, and will be briefly described below.

The detection ID: “Fooo-oooo” shown in FIG. 3 is identification information assigned to each person detected from the image of each frame. Fooo is frame identification information, and information after the hyphen is the identification information of each person detected from the image of each frame. When the same person is detected from images of different frames, a different detection ID is assigned to each of them.

In the third layer, nodes corresponding to each of the all of the detection IDs obtained from the frames processed so far (processed frames) are arranged. Then, the plurality of nodes arranged in the third layer are grouped by putting together the nodes having a similarity (similarity of an appearance feature value) of equal to or more than a first level. In the third layer, a plurality of detection IDs determined to belong to the same person are grouped. The person identification information (person identifier (ID)) is assigned to each group of the third layer.

In the second layer, one node (representative) selected from each of the plurality of groups in the third layer is arranged. Each node of the second layer is linked to the group which is a selection source (the group to which the node belongs) located in the third layer. Then, the plurality of nodes arranged in the second layer are grouped by putting together the nodes having a similarity of equal to or more than a second level. Note that, the second level is lower than the first level. That is, nodes that are not grouped when based on the first level may be grouped when based on the second level.

In the first layer, one node (representative) selected from each of the plurality of groups in the second layer is arranged. Each node in the first layer is linked to the group which is the selection source (the group to which the node belongs) located in the second layer.

The index is updated as follows. When a new detection ID is obtained from a new frame (frame being processed), first, a plurality of detection IDs located in the first layer are set as comparison targets. That is, a pair of the new detection ID and each of the plurality of detection IDs located in the first layer is created. Then, the similarity (similarity of the appearance feature value) is computed for each pair, and it is determined whether the computed similarity is equal to or more than a first threshold (similarity equal to or more than a predetermined level).

In a case where there is no detection ID of which the similarity is equal to or more than the first threshold in the first layer, it is determined that the person corresponding to the new detection ID is not the same person as the person detected before. Then, the new detection ID is added to the first to third layers and they are linked to each other. In the second and third layers, a new group is generated by the added new detection ID. Also, a new person ID is issued in association with the new group in the third layer. Then, the person ID is determined as the person ID of the person corresponding to the new detection ID.

In contrast, when there is a detection ID of which the similarity is equal to or more than the first threshold in the first layer, the comparison target is moved to the second layer. Specifically, the group of the second layer linked to the “detection ID of the first layer of which the similarity is determined to be equal to or more than the first threshold” is set as the comparison target.

Then, a pair of the new detection ID and each of the plurality of detection IDs included in the group to be processed in the second layer is created. Next, the similarity is computed for each pair, and it is determined whether the computed similarity is equal to or more than a second threshold. Note that, the second threshold is greater than the first threshold.

In a case where there is no detection ID of which the similarity is equal to or more than the second threshold in the group to be processed in the second layer, it is determined that the person corresponding to the new detection ID is not the same person as the person detected before. Then, the new detection ID is added to the second layer and the third layer, and linked to each other. In the second layer, the new detection ID is added to the group to be processed. In the third layer, a new group is generated by the added new detection ID. Also, a new person ID is issued in association with the new group in the third layer. Then, the person ID is determined as the person ID of the person corresponding to the new detection ID.

In contrast, in a case where there is a detection ID of which a similarity is equal to or more than the second threshold in the group to be processed in the second layer, it is determined that the person corresponding to the new detection ID is the same person as the person detected before. Then, the new detection ID is made to belong to the group of the third layer linked to the “detection ID of the second layer of which the similarity is determined to be equal to or more than the second threshold”. Further, the person ID associated with the group in the third layer is determined as the person ID of the person corresponding to the new detection ID.

For example, as described above, the detection ID (person) detected from the image of the new frame can be added to the index of FIG. 3 and the person ID can be associated with each detection ID.

Returning to FIG. 2, the computation unit 12 analyzes the image, and computes the movement parameter value indicating the characteristic of the movement of each moving body, for each moving body detected by the moving body detection unit 11. The movement parameter value is, for example, the moving velocity, the moving direction, or the appearance position, but may be other values. Then, the computation unit 12 computes an index indicating variation in the movement parameter value for each moving body. Hereinafter, the index will be referred to as a “variation index”. The variation index indicates how much the movement parameter value of each moving body varies in a moving image of a predetermined length. In the present example embodiment, the method of computing the movement parameter value and the variation index is not particularly limited. An example of the computation method will be described in the following example embodiment.

The target extraction unit 13 extracts a moving body satisfying a predetermined condition as a moving body requiring attention (for example, a suspicious person) based on the variation index computed by the computation unit 12. Specifically, the target extraction unit 13 extracts a moving body for which a movement parameter value varies by a predetermined level or more as a moving body requiring attention. The moving body for which a movement parameter value varies by a predetermined level or more is, for example, in a moving image of a predetermined length, a moving body for which a moving velocity varies by a predetermined level or more, a moving body for which a moving direction varies by a predetermined level or more, a moving body for which an appearance position varies by a predetermined level or more, and the like.

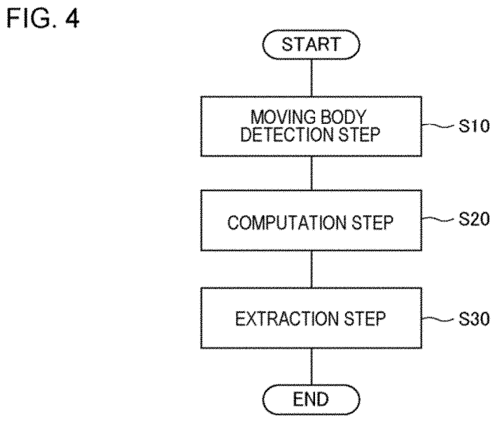

Next, an example of a processing flow of the processing apparatus 10 will be described with reference to the flowchart of FIG. 4.

In S10, the moving body detection unit 11 detects a moving body from the image generated by the camera. For example, the moving body detection unit 11 sets a moving image of a predetermined length as a processing target, and detects moving bodies for each frame. Then, the moving body detection unit 11 groups the moving bodies detected from each frame by the same moving body.

In S20, the computation unit 12 computes, for each moving body detected in S10, a movement parameter value indicating a characteristic of the movement of each moving body. For example, the computation unit 12 computes the moving velocity, the moving direction, the appearance position, and the like for each moving body. Next, the computation unit 12 computes a variation index indicating variation in the movement parameter value for each moving body. For example, the computation unit 12 computes a variation index indicating how much the movement parameter values such as the moving velocity, the moving direction, the appearance position, and the like of each moving body vary in the moving image of a predetermined length.

In S30, the target extraction unit 13 extracts a moving body satisfying a predetermined condition from among the moving bodies detected in S10 as a moving body requiring attention based on the variation index for each moving body computed in S20. Specifically, the target extraction unit 13 extracts a moving body for which a movement parameter value varies by a predetermined level or more in the moving image of the predetermined length.

As described above, the processing apparatus 10 of the present example embodiment can extract, from among the moving bodies detected from the image generated by the camera (for example: surveillance camera), a moving body for which a variation in the movement parameter value (for example: moving velocity, moving direction, appearance position, and the like) indicating the characteristic of the movement satisfies a predetermined condition, as a moving body requiring attention.

A person who is prowling for a criminal inspection or the like takes various actions such as searching for a target, tracking a target, and observing a target. The characteristic of such a person's movement is not constant and may vary. For example, the person may appear at different positions, move in different directions, or move at different velocities.

The processing apparatus 10 of the present example embodiment, which extracts a moving body requiring attention based on variation in movement parameter values indicating the characteristic of the movement, allows a moving body requiring attention to be accurately extracted.

### Second Example Embodiment

The processing apparatus 10 of the present example embodiment computes the moving velocity of the moving body as the movement parameter value, and extracts the moving body for which a moving velocity varies by a predetermined level or more as the moving body requiring attention. Other configurations are similar to those of the first example embodiment.

Hereinafter, a configuration of the processing apparatus 10 will be described in detail. Note that, an example of a hardware configuration of the processing apparatus 10 is the same as that of the first example embodiment.

An example of a functional block diagram of the processing apparatus 10 is shown in FIG. 2 as in the first example embodiment. As illustrated, the processing apparatus 10 includes a moving body detection unit 11, a computation unit 12, and a target extraction unit 13. The configuration of the moving body detection unit 11 is similar to that of the first example embodiment.

The computation unit 12 computes the moving velocity (movement parameter value) of each moving body, for each moving body detected by the moving body detection unit 11. The computation unit 12 sets a moving image of a predetermined length as a processing target, and measures a moving velocity at each of a plurality of timings in the moving image for each moving body. An example of the computation method will be described below.

### Moving Velocity Computation Example 1

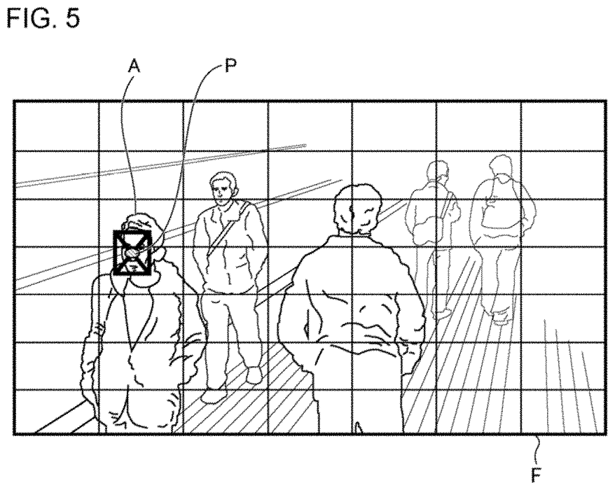

In the example, as shown in FIG. 5, the computation unit 12 divides the image of each frame into a plurality of small areas based on a predetermined rule. F indicates an image of each frame, and A indicates a small area. In the example shown in the drawing, the computation unit 12 divides the image into a total of 49 small areas (7 vertical×7 horizontal).

Then, the computation unit 12 detects in which small area each moving body exists for each frame. For example, the computation unit 12 detects a small area where a predetermined place P (for example, nose or the like) of each moving body exists as a small area where each moving body exists. By arranging the small areas where the moving body exists in each frame in the frame order, a movement locus of each moving body can be detected. Note that, the moving body may exist in the same small area over a plurality of consecutive frames.

Then, based on a period of time T from when a certain moving body (first moving body) is detected in a certain small area (first small area) until the first moving body is detected in another small area (second small area) for the first time, and a distance L between the first small area and the second small area, the computation unit 12 computes the moving velocity (=L/T) of the first moving body moving from the first small area to the second small area. Every time the small area where the moving body exists changes, the computation unit 12 similarly computes the moving velocity of the moving body from the small area where the moving body existed immediately before to the small area where the moving body newly exists.

The distance L can be computed, for example, as a distance between two points in a coordinate system set on the image. The computation unit 12 may compute a distance between a representative point (for example: center) of the first small area and a representative point (for example: center) of the second small area as the distance L.

Note that, the distance L can be computed according to other predetermined rules. In the rule, for example, a distance between two small areas adjacent to each other by a side may be defined as “1”, a distance between two small areas adjacent to each other by a point may be defined as “1.5”, and “a distance when moving between the first small area and the second small area in the shortest distance while moving between the small areas adjacent to each other by a side or a point may be defined as a distance L”.

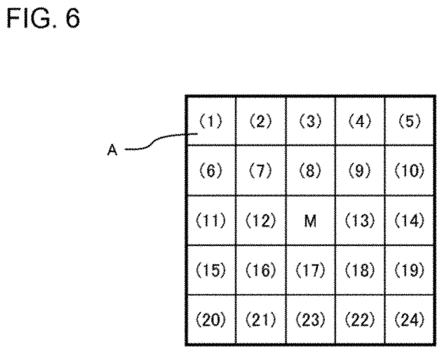

A specific example of computing the distance L according to the rule will be described with reference to FIG. 6. FIG. 6 shows 25 small areas. It is assumed that the first small area is a small area indicated by M.

When the second small area is a small area indicated by (8), the shortest movement route between the first small area (M) and the second small area (8) is a route obtained by directly moving from the first small area (M) to the second small area (8). In this case, a distance L between the first small area (M) and the second small area (8) is 1.

When the second small area is a small area indicated by (9), the shortest movement route between the first small area (M) and the second small area (9) is a route obtained by directly moving from the first small area (M) to the second small area (9). In this case, a distance L between the first small area (M) and the second small area (9) is 1.5.

When the second small area is a small area indicated by (3), the shortest movement route between the first small area (M) and the second small area (3) is a route obtained by moving from the first small area (M) to the small area (8), and then moving to the second small area (3). In this case, a distance L between the first small area (M) and the second small area (3) is 2.

When the second small area is a small area indicated by (4), the shortest movement route between the first small area (M) and the second small area (4) is a route obtained by moving from the first small area (M) to the small area (8), and then moving to the second small area (4). In this case, a distance L between the first small area (M) and the second small area (4) is 2.5.

The time T can be computed, for example, by dividing the number of frames from when the first moving body is detected in the first small area until the first moving body is detected in the second small area for the first time, by the frame rate.

In this way, the computation unit 12 can divide the image into a plurality of small areas, compute the time from the detection of the moving body in a certain small area to the detection of the moving body in another small area, and compute a value obtained by dividing the distance between a certain small area and another small area by the above time as the moving velocity of the moving body for the distance between the certain small area and the other small area. Then, the computation unit 12 can compute the moving velocity of the moving body between the small area in which the moving body is detected immediately before and the small area in which the moving body is newly detected, every time the small area in which the moving body is detected changes.

### Moving Velocity Computation Example 2

In the example, the computation unit 12 determines a position of each person in each frame with the coordinate system set on the image. For example, the computation unit 12 determines coordinates of a predetermined place P (for example, nose or the like) of each moving body as the position of the moving body. By arranging the coordinates of the predetermined place P existing in each frame in the frame order, the movement locus of each moving body can be detected.

Then, the computation unit 12 computes, for each predetermined number of frames (any number equal to or more than 1), an average moving velocity between the frames. Specifically, the average moving velocity can be computed by dividing the distance between the coordinates of the moving body determined in the first frame and the coordinates of the moving body determined in a frame after a predetermined number of frames from the first frame, by the time (=number of frames/frame rate) between the frames.

After computing the moving velocities at a plurality of timings as described above, the computation unit 12 computes a variation index indicating variation in the moving velocities for each moving body detected by the moving body detection unit 11. Hereinafter, an example of a computation formula of the variation index will be described. However, the variation index may be computed by another computation formula.

First, the computation unit 12 divides the moving velocity in the range of v0 to Vmax into a plurality of groups having a predetermined numerical width α. The plurality of groups are, for example, a first group “v0 to v0+α” and a second group “v0+α to v0+2α”. Here, the serial number of each group is “m” and the number of groups is “ns”.

As described above, the computation unit 12 computes the moving velocity at a plurality of timings for each moving body. Therefore, the computation unit 12 determines which group the moving velocity at each timing belongs to, and counts the number of members belonging to each group. The member refers to the moving velocity at each timing.

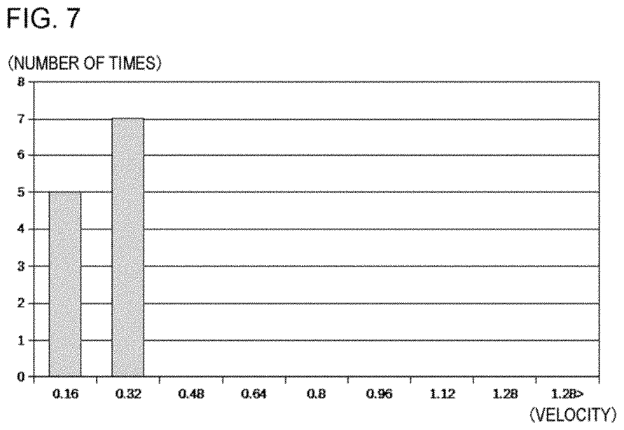

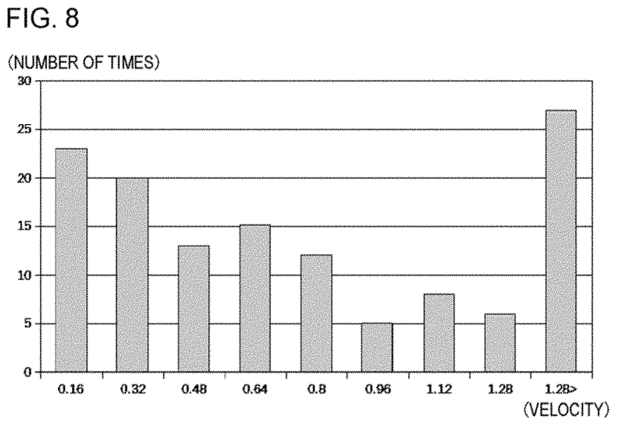

FIGS. 7 and 8 show the results obtained by the count. The horizontal axis indicates each group. In the drawings, the representative value of the moving velocity range of each group is shown. The vertical axis indicates the number of times the movement at each moving velocity is detected. The number is synonymous with the number of members belonging to each group.

Then, the computation unit 12 computes a moving velocity variation index seⱼ for each j based on the following Equation (1). As the moving velocity varies, the variation index seⱼ increases. Note that, j is a moving body identifier (ID).

$${se}_{j} = - {{\sum }_{m = 1}}^{n s} {s}_{mj} log ( {s}_{m j} ) \qquad Equation ( 1 )$$

The computation unit 12 computes sₘⱼ indicated in Equation (1) for each j and for each m based on the following Equation (2).

$${s}_{mj} = \frac{\begin{matrix}number of times movement of moving \\ body j at velocity m is detected\end{matrix} }{\begin{matrix}total number of times movement of moving \\ body j at each velocity is detected\end{matrix}} \qquad Equation ( 2 )$$

The denominator of Equation (2) indicates the total number of times the movement of the moving body j at each velocity is detected. The value of the denominator is the same as the value obtained by adding the number of members belonging to each of the ns groups. The numerator of Equation (2) indicates the number of times the movement of the moving body j at the velocity m is detected. The numerator value is the same as the number of members belonging to group m.

In this way, the computation unit 12 divides the moving velocity into a plurality of numerical ranges in increments of a predetermined value, computes the appearance frequency of the moving velocity of the moving body for each numerical range, and thereby can compute an index indicating the variation in the moving velocity of the moving body based on the computation result.

Note that, the computation unit 12 can determine the numerical width (the predetermined value) of the plurality of numerical ranges for each moving body. For example, the computation unit 12 may determine the predetermined value based on the maximum value of the moving velocity at a plurality of timings computed for each moving body. The predetermined value increases as the maximum value of the moving velocity increases. In this way, it is possible to accurately detect the variation in the moving velocity of each moving body.

Based on the moving velocity variation index seⱼ computed by the computation unit 12, the target extraction unit 13 extracts a moving body satisfying a predetermined condition from among the moving bodies detected by the moving body detection unit 11 as a moving body requiring attention (for example, a suspicious person). Specifically, the target extraction unit 13 extracts a moving body j for which a moving velocity variation index seⱼ is equal to or more than a first reference value, as a moving body requiring attention.

An example of a processing flow of the processing apparatus 10 of the present example embodiment is the same as that of the first example embodiment.

The processing apparatus 10 of the present example embodiment described above can realize the same advantageous effect as that of the first example embodiment.

Further, the processing apparatus 10 of the present example embodiment makes it possible to extract a moving body for which a moving velocity varies as a moving body requiring attention. A person who is prowling for a criminal inspection or the like takes various actions such as searching for a target, tracking a target, and observing a target. Therefore, the moving velocity of the person may vary. The processing apparatus 10 of the present example embodiment, which can extract a moving body for which a moving velocity varies as a moving body requiring attention, allows a suspicious person to be accurately extracted.

### Third Example Embodiment

The processing apparatus 10 of the present example embodiment computes the moving direction of the moving body as the movement parameter value, and extracts a moving body for which a moving direction varies by a predetermined level or more as a moving body requiring attention. Other configurations are similar to those of the first example embodiment.

Hereinafter, a configuration of the processing apparatus 10 will be described in detail. Note that, an example of a hardware configuration of the processing apparatus 10 is the same as that of the first example embodiment.

An example of a functional block diagram of the processing apparatus 10 is shown in FIG. 2 as in the first example embodiment. As illustrated, the processing apparatus 10 includes a moving body detection unit 11, a computation unit 12, and a target extraction unit 13. The configuration of the moving body detection unit 11 is similar to that of the first example embodiment.

The computation unit 12 computes a moving direction (movement parameter value) of each moving body for each moving body detected by the moving body detection unit 11. The computation unit 12 sets a moving image of a predetermined length as a processing target, and detects a moving direction at each of a plurality of timings in the moving image for each moving body. An example of the computation method will be described below.

### Moving Direction Computation Example 1

In the example, as shown in FIG. 5, the computation unit 12 divides the image of each frame into a plurality of small areas based on a predetermined rule. F indicates an image of each frame, and A indicates a small area. In the example shown in the drawing, the computation unit 12 divides the image into a total of 49 small areas (7 vertical×7 horizontal).

Then, the computation unit 12 detects in which small area each moving body exists for each frame. For example, the computation unit 12 detects a small area where a predetermined place P (for example, nose or the like) of each moving body exists as a small area where each moving body exists. By arranging the small areas where the moving body exists in each frame in the frame order, a movement locus of each moving body can be detected. Note that, the moving body may exist in the same small area over a plurality of consecutive frames.

Then, after a certain moving body (first moving body) is detected in a certain small area (first small area), when the first moving body is detected in another small area (second small area) for the first time, the computation unit 12 determines that the first moving body is moved from the first small area toward the second small area.

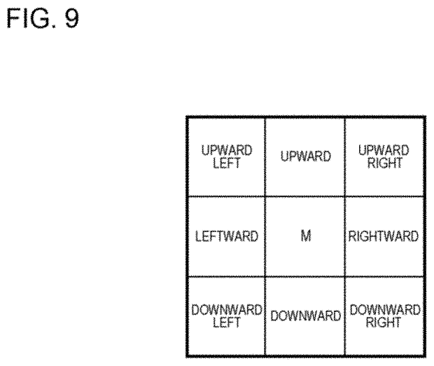

The moving direction between the two small areas may be defined as shown in FIG. 9, for example. FIG. 9 shows nine small areas. It is assumed that the first small area is a small area indicated by M. As shown in the drawing, the moving direction from the small area (M) in which the moving body is currently positioned to each of the surrounding small areas is defined. In the case of the shown example, eight moving directions of upward, downward, rightward, leftward, upward right, downward right, upward left, and downward left are defined.

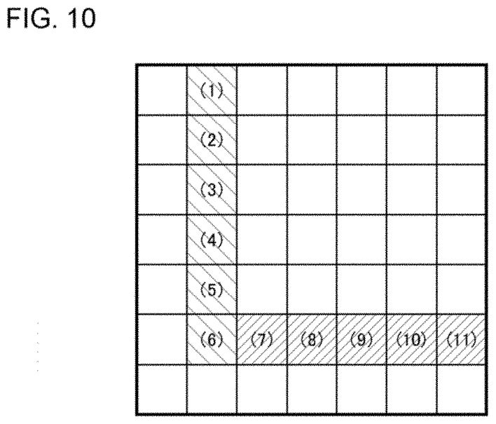

Here, a specific example will be described with reference to FIG. 10. As shown in the drawing, it is assumed that the moving body is detected in the small area (1) to small area (11) in the order of numbers. In this case, the moving direction from the small area (1) to the small area (2) is “downward”. The moving direction from the small area (2) to the small area (3) is “downward”. In this way, the computation unit 12 determines the moving direction in the movement from the small area (1) to the small area (11). As a result, the contents “downward”, “downward”, “downward”, “downward”, “downward”, “rightward”, “rightward”, “rightward”, “rightward”, “rightward” are determined.

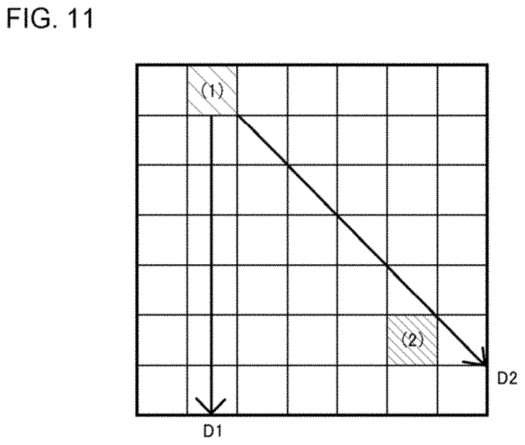

Note that, as shown in FIG. 11, the first small area (1) may not be adjacent to the second small area (2) detected immediately thereafter. In such a case, the computation unit 12 determines the moving direction of the movement from the first small area (1) to the second small area (2) according to a predetermined rule.

For example, the computation unit 12 computes the distance between each of a “movement locus D1 obtained by moving from the first small area (1) downwardly through small areas adjacent to each other by sides” and a “movement locus D2 obtained by moving from the first small area (1) in a diagonally downward right direction through the small areas adjacent to each other by points” and the second small area (2), and determines the movement locus having the smaller distance. Then, the computation unit 12 determines that the moving direction of the movement from the first small area (1) to the second small area (2) is “downward” in a case where the movement locus D1 has a smaller distance from the second small area (2). In contrast, the computation unit 12 determines that the moving direction of the movement from the first small area (1) to the second small area (2) is “downward right” in a case where the movement locus D2 has a smaller distance from the second small area (2). Note that, the example described here is merely an example, and the present invention is not limited to this.

In this way, the computation unit 12 can divide the image into a plurality of small areas, and compute the direction from the small area in which the moving body is detected immediately before to the small area in which the moving body is newly detected as the moving direction of the moving body, every time the small area in which the moving body is detected changes. Then, every time the small area where the moving body is detected changes, the computation unit 12 can compute the moving direction of the moving body based on the small area in which the moving body is detected immediately before and the small area in which the moving body is newly detected.

### Moving Direction Computation Example 2

In the example, the computation unit 12 determines a position of each person in each frame with the coordinate system set on the image. For example, the computation unit 12 determines coordinates of a predetermined place P (for example, nose or the like) of each moving body as the position of the moving body. By arranging the coordinates of the predetermined place P existing in each frame in the frame order, the movement locus of each moving body can be detected.

Then, the computation unit 12 computes, for each predetermined number of frames (any number of equal to or more than 1), an average moving direction between the frames. Specifically, the direction from the coordinates of the moving body determined in the first frame to the coordinates of the moving body determined in a frame after a predetermined number of frames from the first frame can be computed as the moving direction of the moving body. For example, the upward direction of the image may be defined as 0°, the right direction may be defined as 90°, the downward direction may be defined as 180°, and the left direction may be defined as 270°, and the moving direction may be represented by an angle. In this case, the computation unit 12 can express the moving direction computed by the angle by the concept of upward, downward, rightward, leftward, upward right, downward right, upward left, downward left, and the like by defining the angle range corresponding to each direction such as upward, downward, rightward, leftward, upward right, downward right, upward left, downward left, and the like. Note that, here, an example in which the range of 0° to 360° is divided into eight groups has been described, but the number is not limited to this.

After computing the moving direction at a plurality of timings as described above, the computation unit 12 computes a variation index indicating the variation in the moving direction for each moving body detected by the moving body detection unit 11. Hereinafter, an example of a computation formula of the variation index will be described. However, the variation index may be computed by another computation formula.

As described above, the computation unit 12 detects the moving direction at a plurality of timings for each moving body. Therefore, the computation unit 12 counts the number of times the movement in each direction is detected for each moving direction.

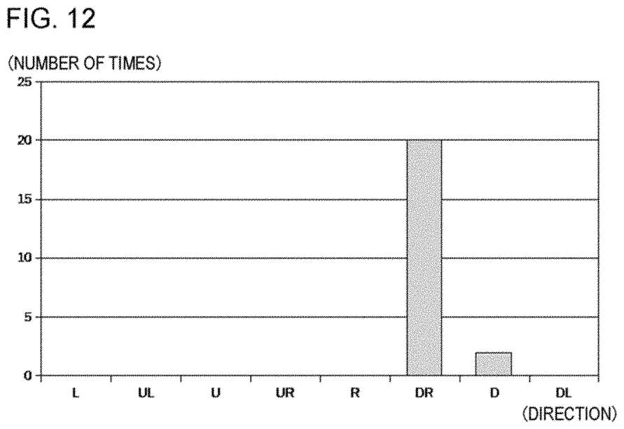

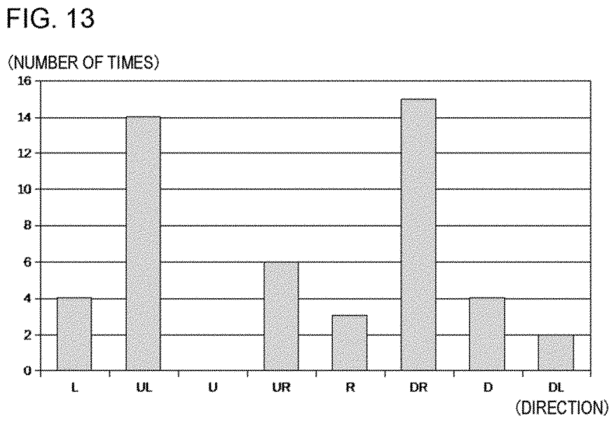

FIGS. 12 and 13 show the results obtained by the count. The horizontal axis indicates each moving direction. L means leftward, UL means upward left, U means upward, UR means upward right, R means rightward, DR means downward right, D means downward, and DL means downward left. The vertical axis indicates the number of times the movement in each moving direction is detected.

Then, the computation unit 12 computes a moving direction variation index deⱼ for each j based on the following Equation (3). As the moving direction varies more, the variation index deⱼ increases. Note that, j is an ID of the moving body. k is an ID of the moving direction. nd is the number of the moving directions. When the moving direction is represented by eight directions of upward, downward, rightward, leftward, upward right, downward right, upward left, downward left, nd is 8.

$$d {e}_{j} = - {\sum }_{k = 1}^{n d} {d}_{k j} log ( {d}_{k j} ) \qquad Equation ( 3 )$$

The computation unit 12 computes dₖⱼ indicated by Equation (3) for each j and for each k, based on the following Equation (4).

$${d}_{kj} = \frac{\begin{matrix}number of times movement of moving \\ body j in moving direction k is detected\end{matrix}}{\begin{matrix}total number of times movement of moving \\ body j in each moving direction is detected\end{matrix}} \qquad Equation ( 4 )$$

The denominator of Equation (4) indicates the total number of times the movement of the moving body j in each moving direction is detected. The numerator of Equation (4) indicates the number of times the movement of the moving body j in the moving direction k is detected.

Based on the moving direction variation index deⱼ computed by the computation unit 12, the target extraction unit 13 extracts a moving body satisfying a predetermined condition from among the moving bodies detected by the moving body detection unit 11 as a moving body requiring attention (for example, a suspicious person). Specifically, the target extraction unit 13 extracts a moving body j for which a moving direction variation index deⱼ is equal to or more than a second reference value as the moving body requiring attention.

An example of a processing flow of the processing apparatus 10 of the present example embodiment is the same as that of the first example embodiment.

The processing apparatus 10 of the present example embodiment described above can realize the same advantageous effect as that of the first example embodiment.

Further, the processing apparatus 10 of the present example embodiment makes it possible to extract a moving body for which a moving direction varies as a moving body requiring attention. A person who is prowling for a criminal inspection or the like takes various actions such as searching for a target, tracking a target, and observing a target. Therefore, the moving direction of the person may vary. The processing apparatus 10 of the present example embodiment, which can extract a moving body for which a moving direction varies as a moving body requiring attention, allows a suspicious person to be accurately extracted.

### Fourth Example Embodiment

The processing apparatus 10 of the present example embodiment computes the appearance position of the moving body as the movement parameter value, and extracts the moving body for which the appearance position varies by a predetermined level or more as the moving body requiring attention. Other configurations are similar to those of the first example embodiment.

Hereinafter, a configuration of the processing apparatus 10 will be described in detail. Note that, an example of a hardware configuration of the processing apparatus 10 is the same as that of the first example embodiment.

An example of a functional block diagram of the processing apparatus 10 is shown in FIG. 2 as in the first example embodiment. As illustrated, the processing apparatus 10 includes a moving body detection unit 11, a computation unit 12, and a target extraction unit 13. The configuration of the moving body detection unit 11 is similar to that of the first example embodiment.

The computation unit 12 computes the appearance position (movement parameter value) of each moving body for each moving body detected by the moving body detection unit 11. The computation unit 12 sets a moving image of a predetermined length as a processing target, and detects an appearance position in the moving image at each of a plurality of timings for each moving body. An example of the computation method will be described below.

For example, the computation unit 12 divides the image of each frame into a plurality of small areas based on the predetermined rule, as shown in FIG. 5. F indicates an image of each frame, and A indicates a small area. In the example shown in the drawing, the computation unit 12 divides the image into a total of 49 small areas (7 vertical×7 horizontal). Then, the computation unit 12 determines the small area where the predetermined place P (for example, nose or the like) of each moving body exists as the small area where each moving body exists. The computation unit 12 performs the same processing on each of the images of the plurality of frames to determine the small area where each moving body exists for each frame. Then, the computation unit 12 computes the number of frames in which each moving body exists in each small area and the time during which each moving body exists in each small area (=number of frames/frame rate) based on the determination result.

Next, the computation unit 12 computes a variation index indicating the variation in the appearance position for each moving body detected by the moving body detection unit 11. Hereinafter, an example of a computation formula of the variation index will be described. However, the variation index may be computed by another computation formula.

The computation unit 12 computes an appearance position variation index peⱼ for each j based on the following Equation (5). As the appearance position varies more, the variation index peⱼ increases. Note that, j is an ID of the moving body, i is an ID of the small area A, and ni is the number of the small areas A.

$${pe}_{j} = - {{\sum }_{i = 1}}^{ni} {p}_{i j} log ( {p}_{i j} ) \qquad Equation ( 5 )$$

The computation unit 12 computes pᵢⱼ indicated by Equation (5) for each j and for each i based on the following Equation (6) or Equation (7).

$$\begin{matrix}{p}_{ij} = \frac{\begin{matrix}total number of frames in which moving \\ body j exists in small area i\end{matrix}}{\begin{matrix}number of frames in which moving \\ body j exists in image\end{matrix}} & Equation ( 6 ) \\ {p}_{ij} = \frac{\begin{matrix}total time during which moving \\ body j exists in small area i\end{matrix}}{\begin{matrix}time during which moving \\ body j exists in image\end{matrix}} & Equation ( 7 )\end{matrix}$$

The denominator of Equation (6) is the total number of frames in which the moving body j exists in the image (total number of frames in which the moving body j is detected). The numerator of the Equation (6) is the total number of frames in which the moving body j exists in the small area i (total number of frames from which the moving body j is detected in the small area i).

The denominator of Equation (7) is the time during which the moving body j exists in the image (=total number of frames from which the moving body j is detected/frame rate). The numerator of Equation (7) is the time during which the moving body j exists in the small area i (=total number of frames from which moving body j is detected in the small area i/frame rate).

Based on the appearance position variation index peⱼ computed by the computation unit 12, the target extraction unit 13 extracts a moving body satisfying a predetermined condition from among the moving bodies detected by the moving body detection unit 11 as a moving body requiring attention (for example, a suspicious person). Specifically, the target extraction unit 13 extracts a moving body j for which an appearance position variation index peⱼ is equal to or more than a third reference value as the moving body requiring attention.

An example of a processing flow of the processing apparatus 10 of the present example embodiment is the same as that of the first example embodiment.

The processing apparatus 10 of the present example embodiment described above allows the same advantageous effect as that of the first example embodiment to be realized.

Further, the processing apparatus 10 of the present example embodiment makes it possible to extract a moving body for which an appearance position varies, as a moving body requiring attention. A person who is prowling for a criminal inspection or the like takes various actions such as searching for a target, tracking a target, and observing a target. Therefore, the appearance position of the person may vary. The processing apparatus 10 of the present example embodiment, which can extract a moving body for which an appearance position varies as a moving body requiring attention, allows a suspicious person to be accurately extracted.

### Fifth Example Embodiment

The processing apparatus 10 of the present example embodiment computes a movement variation index of the moving body j by using any two or all of the moving velocity variation index seⱼ, the moving direction variation index deⱼ, and the appearance position variation index peⱼ, and extracts a moving body requiring attention based on the movement variation index.

Hereinafter, a configuration of the processing apparatus 10 will be described in detail. Note that, an example of a hardware configuration of the processing apparatus 10 is the same as that of the first example embodiment.

An example of a functional block diagram of the processing apparatus 10 is shown in FIG. 2 as in the first example embodiment. As illustrated, the processing apparatus 10 includes a moving body detection unit 11, a computation unit 12, and a target extraction unit 13. The configuration of the moving body detection unit 11 is similar to that of the first example embodiment.

The computation unit 12 performs computation by using any two or all of the moving velocity variation index seⱼ, the moving direction variation index deⱼ, and the appearance position variation index peⱼ. Each computation method is as described in the second to fourth example embodiments.

Then, the computation unit 12 computes the movement variation index IM of the moving body j based on the following Equations (8) and (9). IM indicates the variation of at least two movement parameter values.

$$\begin{matrix}‖ p {e}_{j} ‖ = \frac{p {e}_{j}}{log {N}_{p}} , ‖ d {e}_{j} ‖ = \frac{d {e}_{j}}{log {N}_{d}} , ‖ {se}_{j} ‖ = \frac{s {e}_{j}}{log {N}_{s}} & Equation ( 8 ) \\ IM = ‖ p {e}_{j} ‖ + ‖ d {e}_{j} ‖ + ‖ {se}_{j} ‖ & Equation ( 9 )\end{matrix}$$

Note that, the image of each frame is divided into a plurality of small areas when the processing of computing the appearance position variation index peⱼ is performed, and Nₚ in Equation (8) indicates the total number of the small areas generated by the processing. Further, the image of each frame may be divided into a plurality of small areas when the processing of computing the moving direction variation index deⱼ is performed, and Na in Equation (8) indicates the total number of the small areas generated by the processing. Further, the image of each frame may be divided into a plurality of small areas when the processing of computing a moving velocity variation index seⱼ is performed, and Ns in Equation (8) indicates the total number of small areas generated in the processing.

Equation (9) is for computing the movement variation index of the moving body j, by using all of the moving velocity variation index seⱼ, the moving direction variation index deⱼ, and the appearance position variation index peⱼ. When computing the movement variation index of the moving body j by using any two of the moving velocity variation index seⱼ, the moving direction variation index deⱼ, and the appearance position variation index peⱼ, any of the following Equations (10) to (12) can be used.

IM=∥peⱼ∥+∥deⱼ∥ Equation (10)

IM=∥deⱼ∥+∥seⱼ∥ Equation (11)

IM=∥peⱼ∥+∥seⱼ∥ Equation (12)

The target extraction unit 13 extracts a moving body for which a movement variation index IM indicating the variation of at least two movement parameter values satisfies a predetermined condition, as a moving body requiring attention. Specifically, the target extraction unit 13 extracts a moving body j for which a movement variation index IM is equal to or more than a fourth reference value, as a moving body requiring attention.

An example of a processing flow of the processing apparatus 10 of the present example embodiment is the same as that of the first example embodiment.

The processing apparatus 10 of the present example embodiment described above can realize the same advantageous effects as those of the first to fourth example embodiments. Further, the processing apparatus 10 of the present example embodiment makes it possible to extract a moving body requiring attention based on variations in a plurality of movement characteristics (a plurality of movement parameter values) of the moving body, thereby allowing a suspicious person to be accurately extracted.

### Modification Example

Here, a modification example applicable to the second to fifth example embodiments will be described. In the example in which the computation unit 12 divides the image into a plurality of small areas as shown in FIG. 5 and computes the moving velocity, the moving direction, the appearance position, and the like by using the small areas, the computation unit 12 may divide the image into a plurality of small areas different in at least one of a shape and a size depending on the position in the image.

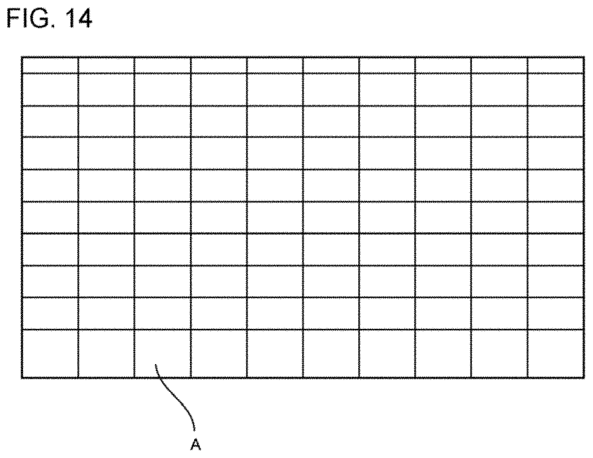

FIG. 14 shows an example in which the computation unit 12 divides the image into a plurality of small areas. In the shown example, the small area positioned on the upper side of the image has a shorter length than the small area positioned on the lower side of the image in the vertical direction. In addition, the length of the small area in the left-right direction may differ depending on the position of the image in the left-right direction.

In the case of the modification example, it is possible to accurately evaluate variations in the moving velocity, moving direction, appearance position, and the like of the moving body without being affected by the position in the image. As a result, a suspicious person can be accurately extracted.

Hereinafter, examples of a reference example embodiment will be additionally described.

1. A processing apparatus including:

a moving body detection unit that detects a moving body from an image generated by a camera;

a computation unit that computes a movement parameter value which indicates a characteristic of a movement of each of the moving bodies for each moving body, and computes an index which indicates variation in the movement parameter value for each moving body, and

a target extraction unit that extracts the moving body which satisfies a predetermined condition, based on the index.

2. The processing apparatus according to 1,

in which the computation unit computes a moving velocity of the moving body as the movement parameter value.

3. The processing apparatus according to 2,

in which the computation unit

divides the image into a plurality of small areas,

computes time from when the moving body is detected in a certain small area to when the moving body is detected in another small area, and

computes a value obtained by dividing a distance between the certain small area and the other small area by the time, as the moving velocity of the moving body between the certain small area and the other small area.

4. The processing apparatus according to 3,

in which the computation unit

computes the moving velocity of the moving body between the small area in which the moving body is detected immediately before and the small area in which the moving body is newly detected, every time the small area in which the moving body is detected changes.

5. The processing apparatus according to 3 or 4,

in which the computation unit

divides a range of the moving velocity into a plurality of numerical ranges in increments of a predetermined value, and

computes an appearance frequency of the moving velocity of the moving body for each numerical range, and based on the computation result, computes an index indicating variation in the moving velocity of the moving body.

6. The processing apparatus according to 5,

in which the computation unit

decides the predetermined value indicating a numerical width of the numerical range based on a maximum value of the computed moving velocity for each moving body.

7. The processing apparatus according to any one of 1 to 6,

in which the computation unit computes a moving direction of the moving body as the movement parameter value.

8. The processing apparatus according to 7,

in which the computation unit

divides the image into a plurality of small areas, and

computes a direction from the small area in which the moving body is detected immediately before to the small area in which the moving body is newly detected as the moving direction of the moving body, every time the small area in which the moving body is detected changes.

9. The processing apparatus according to any one of 1 to 8,

in which the computation unit computes an appearance position of the moving body as the movement parameter value.

10. The processing apparatus according to 9,

in which the computation unit

divides the image into a plurality of small areas, and

computes the number of frames in which the moving body exists or time during which the moving body exists, for each small area.

11. The processing apparatus according to any one of 3 to 6, 8, and 10,

in which the computation unit divides the image into the plurality of the small areas different in at least one of a shape and a size according to a position of the moving body in the image.

12. The processing apparatus according to any one of 1 to 11,

in which the computation unit

computes at least two of a moving velocity of the moving body, a moving direction of the moving body, and an appearance position of the moving body as the movement parameter value, and

the target extraction unit

extracts the moving body for which the index indicating variation in the at least two movement parameter values satisfies the predetermined condition.

13. The processing apparatus according to any one of 1 to 12,

in which the target extraction unit extracts the moving body for which the movement parameter value varies by a predetermined level or more.

14. A processing method executed by a computer, the method including:

a moving body detection step of detecting a moving body from an image generated by a camera,

a computation step of computing a movement parameter value which indicates a characteristic of a movement of each of the moving bodies for each moving body, and computing an index which indicates variation in the movement parameter value for each moving body, and

a target extraction step of extracting the moving body which satisfies a predetermined condition, based on the index.

15. A program causing a computer to function as:

a moving body detection unit that detects a moving body from an image generated by a camera,

a computation unit that computes a movement parameter value which indicates a characteristic of a movement of each of the moving bodies for each moving body, and computes an index which indicates variation in the movement parameter value for each moving body, and

a target extraction unit that extracts the moving body which satisfies a predetermined condition, based on the index.

1. A processing apparatus comprising:
at least one memory configured to store one or more instructions; and
at least one processor configured to execute the one or more instructions to:
detect a moving body from an image generated by a camera;
compute a movement parameter value which indicates a characteristic of a movement of each of the moving bodies for each moving body, and compute an index which indicates variation in the movement parameter value for each moving body; and
extract the moving body which satisfies a predetermined condition, based on the index.

2. The processing apparatus according to claim 1,
wherein the processor is further configured to execute the one or more instructions to compute a moving velocity of the moving body as the movement parameter value.

3. The processing apparatus according to claim 2,
wherein the processor is further configured to execute the one or more instructions to:
divide the image into a plurality of small areas,
compute time from when the moving body is detected in a certain small area to when the moving body is detected in another small area, and
compute a value obtained by dividing a distance between the certain small area and the other small area by the time, as the moving velocity of the moving body between the certain small area and the other small area.

4. The processing apparatus according to claim 3,
wherein the processor is further configured to execute the one or more instructions to compute the moving velocity of the moving body between the small area in which the moving body is detected immediately before and the small area in which the moving body is newly detected, every time the small area in which the moving body is detected changes.

5. The processing apparatus according to claim 3,
wherein the processor is further configured to execute the one or more instructions to:
divide a range of the moving velocity into a plurality of numerical ranges in increments of a predetermined value, and
compute an appearance frequency of the moving velocity of the moving body for each numerical range, and based on the computation result, compute an index indicating variation in the moving velocity of the moving body.

6. The processing apparatus according to claim 5,
wherein the processor is further configured to execute the one or more instructions to decide the predetermined value indicating a numerical width of the numerical range based on a maximum value of the computed moving velocity for each moving body.

7. The processing apparatus according to claim 1,
wherein the processor is further configured to execute the one or more instructions to compute a moving direction of the moving body as the movement parameter value.

8. The processing apparatus according to claim 7,
wherein the processor is further configured to execute the one or more instructions to:
divide the image into a plurality of small areas, and
compute a direction from the small area in which the moving body is detected immediately before to the small area in which the moving body is newly detected as the moving direction of the moving body, every time the small area in which the moving body is detected changes.

9. The processing apparatus according to claim 1,
wherein the processor is further configured to execute the one or more instructions to compute an appearance position of the moving body as the movement parameter value.

10. The processing apparatus according to claim 9,
wherein the processor is further configured to execute the one or more instructions to:
divide the image into a plurality of small areas, and
compute the number of frames in which the moving body exists or time during which the moving body exists, for each small area.

11. The processing apparatus according to claim 3,
wherein the processor is further configured to execute the one or more instructions to divide the image into the plurality of the small areas different in at least one of a shape and a size according to a position of the moving body in the image.

12. The processing apparatus according to claim 1,
wherein the processor is further configured to execute the one or more instructions to:
compute at least two of a moving velocity of the moving body, a moving direction of the moving body, and an appearance position of the moving body as the movement parameter value, and
extract the moving body for which the index indicating variation in the at least two movement parameter values satisfies the predetermined condition.

13. The processing apparatus according to claim 1,
wherein the processor is further configured to execute the one or more instructions to extract the moving body for which the movement parameter value varies by a predetermined level or more.

14. A processing method executed by a computer, the method comprising:
detecting a moving body from an image generated by a camera;
computing a movement parameter value which indicates a characteristic of a movement of each of the moving bodies for each moving body, and computing an index which indicates variation in the movement parameter value for each moving body; and
extracting the moving body which satisfies a predetermined condition, based on the index.

15. A non-transitory storage medium storing a program causing a computer to:
detect a moving body from an image generated by a camera;
compute a movement parameter value which indicates a characteristic of a movement of each of the moving bodies for each moving body, and compute an index which indicates variation in the movement parameter value for each moving body; and
extract the moving body which satisfies a predetermined condition, based on the index.
